(19) United States
(12) Patent Application Publication
(10) Pub. No.: US 2019/0051323 A1
(43) Pub. Date: Feb. 14, 2019

(54) ACOUSTIC MEASUREMENT SURROGATE FOR DISC DRIVE

(71) Applicant: Seagate Technology LLC, Cupertino, CA (US)

(72) Inventors: Ted Jonathan Wiegandt, Eagan, MN (US); Joshua Schaefer, Eden Prairie, MN (US); James D. Conrad, Shakopee, MN (US)

(21) Appl. No.: 15/674,405

(22) Filed: Aug. 10, 2017

(51) Int. Cl. G11B 5/455; G01H 1/00

(52) U.S. Cl. CPC G11B 5/455; G01H 1/003

(57) ABSTRACT

An acoustic measurement device for a disc drive, the measurement device having a form factor the same as the disc drive's form factor. The device has at least one microphone on an exterior surface of its housing and appropriate circuitry within the housing connecting the at least one microphone to an external device, such as a digital analog converter. As an example, an acoustic measurement device that is a surrogate for a 3½ inch disc drive can have 12 microphones.

### BACKGROUND

Hard disc drives are common information storage devices having a series of rotatable discs having numerous data tracks that are accessed by magnetic reading and writing elements (read head, write head) on a slider, which is supported by an actuator. To obtain more data storage on each disc, the size (width) of the tracks and the size of the slider are decreasing. With the decreasing element sizes, their alignment must be more accurate and any offset can be problematic. For example, offset of the slider by as little as 0.3 microinch can result in data reading and/or writing errors. Such a small offset can readily be caused by vibrations, such as acoustics (noise).

What would be beneficial is a standard device for measuring the acoustics to which a disc drive is exposed.

### SUMMARY

This disclosure is directed to an acoustic (noise) measurement device that is a surrogate for a disc drive to measure the acoustics to which the disc drive is exposed. The measurement device is able to measure the acoustics to which the disc drive is exposed in real time and in-place.

One particular implementation described herein is an acoustic measurement device for a disc drive, the measurement device having a housing having a form factor the same as the disc drive's form factor. The device has at least one microphone on an exterior surface of the housing and appropriate circuitry within the housing connecting the at least one microphone to a digital analog converter.

Another particular implementation described herein is a method of measuring noise affecting a disc drive, in place and in operation. The method includes inserting an acoustic measurement device into an apparatus allotted to receive a disc drive with a form factor, the acoustic measurement device having the same form factor and at least one microphone on an exterior surface thereof, and operating the apparatus and collecting acoustic data from the microphone. From the data, producing a report related to throughput performance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTION OF THE DRAWING

The described technology is best understood from the following Detailed Description describing various implementations read in connection with the accompanying drawing.

FIG. 1 is a schematic, perspective view of an example storage system having multiple disc drives therein.

FIG. 2 is a plan view of an acoustic measurement surrogate device for a disc drive.

FIG. 3 is a plan view of the inside of the acoustic measurement surrogate device of FIG. 2.

FIG. 4 is an exploded perspective view of the housing of the acoustic measurement surrogate device of FIG. 2.

FIG. 5 is a perspective view of an acoustic measurement surrogate device.

FIG. 6 is a top plan view of the acoustic measurement surrogate device of FIG. 5.

FIG. 7 is a bottom plan view of the acoustic measurement surrogate device of FIG. 5.

FIG. 8 is a left side plan view of the acoustic measurement surrogate device of FIG. 5, with the right side plan view being the same.

FIG. 9 is a back side plan view of the acoustic measurement surrogate device of FIG. 5.

FIG. 10 is a front side plan view of the acoustic measurement surrogate device of FIG. 5.

### DETAILED DESCRIPTION

Hard disc drives are common information storage devices having a series of rotating discs that are accessed by magnetic reading and writing elements. A typical desktop computer has one disc drive that may have multiple discs. A server or other large data storage system has multiple disc drives, often hundreds. These large-scale storage systems are often referred to as “racks.” Throughout this discussion, “storage system,” “data storage system,” “rack,” and variations thereof, are used interchangeably.

For brevity, the description from hereon will be directed primarily to these large-scale data storage systems, or racks, although it will be appreciated that the acoustic surrogate device and methods are equally applicable to large-scale servers, desktop computers, NAS systems, and any other device or apparatus that has a disc drive therein.

Storage systems typically include multiple media (e.g., disc drives) arranged somehow to enable data to be written to and read from individual media. The multiple media are interconnected to storage interface modules to create a storage system. Although the description herein is directed to the media being rotatable disc drives, the acoustic surrogate device and methods can be applied to other data storage media, such as solid state drives.

As the size and capacity of the large scale storage systems increase, there is an increasing need to provide efficient and effective means for temperature control and, in particular, cooling of the media within the storage system. Typically, a storage system includes storage modules that each contain multiple disc drives and storage interface modules which provide internal and external connectivity between the storage media and the storage system external data fabric. It is known to pass cooling air through the storage system, via fans, to remove heat produced in operation by the disc drives and thereby provide cooling to the storage system as a whole. These fans, along with other equipment in or near the storage system, produce noise that can detrimentally affect the operation of the disc drive(s).

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

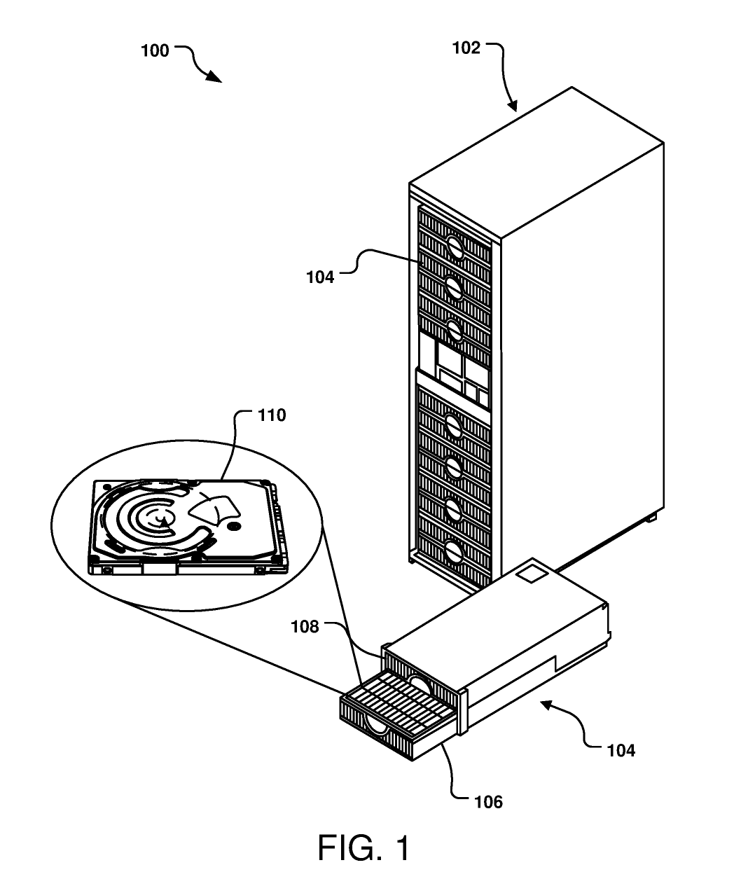

FIG. 1 illustrates an example large-scale storage system 100. In this particular example, the storage system 100 is a drawer-based system that uses a sliding drawer the full (or half) the width of the rack, but of low height. The height is governed by the storage media (or storage interface modules) installed in the drawers, such that a single storage medium, e.g. an individual disk drive, is accessible and serviceable from the top of the drawer. The drawer is supported at its sides by the rack structure, relying on the strength of the drawer itself to provide support for the installed storage media.

The storage system 100 has a rack or housing 102 with a plurality of drawers 104 slideable into and out from the housing 102. In this system 100, each drawer 104 may hold two subdrawers 106, 108, each of which is slideable independently within the drawer 104. Sliding the subdrawers 106, 108 provides access to the multiple disc drives 110 that are present in each subdrawer 106, 108.

Not seen in FIG. 1, the system 100 has at least one fan within each drawer 104 within the housing 102, to move cooling air about the drawers 104 to cool the disc drives 110. This fan, and other equipment in or near the storage system 100, can produce noise that can detrimentally affect the operation of the disc drives 110.

An alternate example of a large-scale storage structure is a ‘blade’ type structure system. The ‘blade’ system is high but narrow, allowing multiple blades to be fitted across the width of the rack, typically 10 or 12. Each ‘blade’ holds multiple disc drives. Similar to the drawer system 100, a ‘blade’ system has at least one fan to move cooling air about the blades to cool the disc drives. This fan, and other equipment in or near the storage system, can produce noise that can detrimentally affect the operation of the disc drives.

The present disclosure provides an acoustic measurement device having the form factor of a disc drive. The acoustic measurement device is a surrogate, measuring the acoustics (noise) to which the disc drive is exposed while in place, in real time. With the acoustic measurement surrogate device, an accurate understanding of the noise to which the disc drive is exposed can be obtained, thus facilitating an estimation of hard drive throughput performance. By knowing the performance, the physical features and/or control systems of the disc drive can be modified to better accept and/or withstand the noise and its effect on the operation of the disc drive.

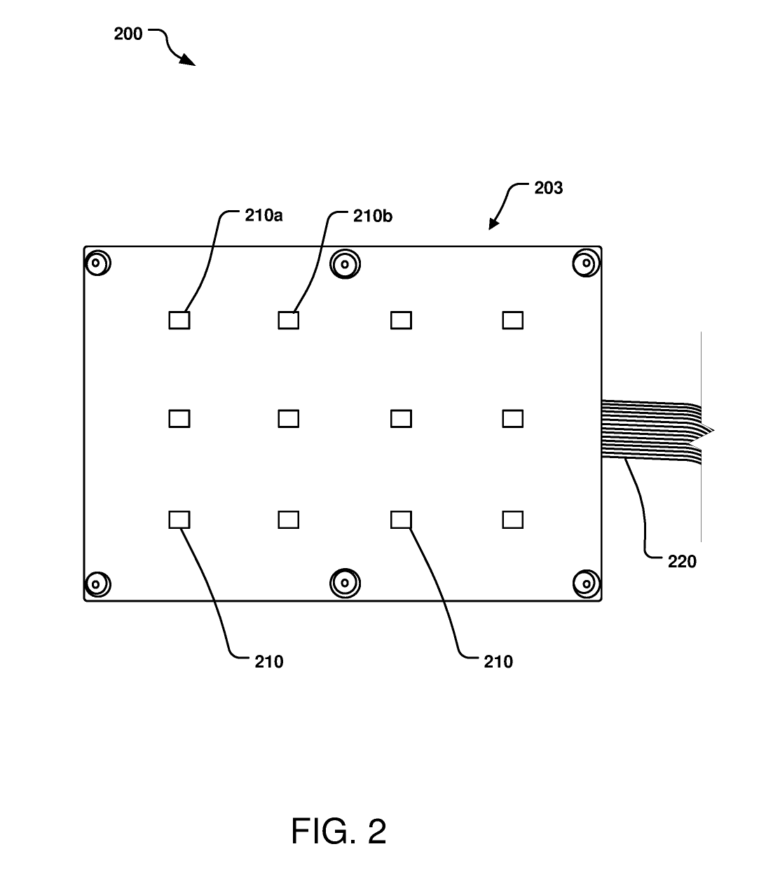

FIG. 2 illustrates an example acoustic measurement surrogate device 200. The surrogate device 200 has the same form factor of the disc drive for which the device 200 is configured to measure noise. For example, a disc drive commonly referred to as a 3½ inch drive has housing size of about 4×5½×1 inches (a cuboid); thus, the device 200 for that drive will have the same size. As another example, a disc drive commonly referred to as a 2½ inch drive has a size of about 2¾×4×0.6 inches.

The acoustic measurement surrogate device 200 has a form defined by a housing 203 (having the same form factor as the disc drive of which it will be measuring the noise exposure) with a plurality of microphones 210 present in at least one side of the housing 203. In this particular implementation, 12 microphones are systemically arranged (in a 3×4 array) on one side of the housing 203; this particular acoustic measurement device 200 is a surrogate for a 3½ inch drive. The acoustic measurement surrogate device 200 has at least 1 microphone, but typically will have at least 2 microphones, in some implementations at least 4 microphones. The microphones may be present on one side of the housing or may be present on more than one side, e.g., on opposing faces of the housing. As an example, a 2½ inch drive may have 6 microphones, systemically arranged in a 2×3 array on one side of the housing. In general, the more microphones present on the acoustic measurement surrogate device 200, the better for determining the level of noise to which the disc drive is exposed and its distribution.

It has been found that even adjacent microphones, e.g., microphone 210a and microphone 210b, are exposed to different noise levels (dB) and/or frequency (Hz). Adjacent microphones, e.g., 210a and 210b, could have a 5 dB or greater difference in the measured noise. At least for this reason, each microphone 210 is independent from the other.

In the particular illustrated implementation, each microphone 210 is positioned in a recess or aperture 211 in the housing 203, so that the microphone 210 does not extend above the level of the surface of the housing 203. In some implementations, the microphones 210 are flush mounted with the surface of the housing 203.

Examples of suitable microphones 210 are small, compact, have a high frequency range, e.g., 2000-10,000 Hz. MEMS microphones, such as those used in cell phones and other portable devices, are inexpensive, readily available and work well for this application.

The acoustic measurement surrogate device 200 also has a wiring harness 220 to connect the acoustic measurement surrogate device 200 to an external data receiver. The wiring harness 220 includes a lead extending from each microphone 210 inside the housing 203 to a terminal end (not shown in FIG. 2) having an adaptor to be plugged into a receiver, such as a digital analog converter (DAC) that has appropriate hardware and software to provide a report from the measured noise.

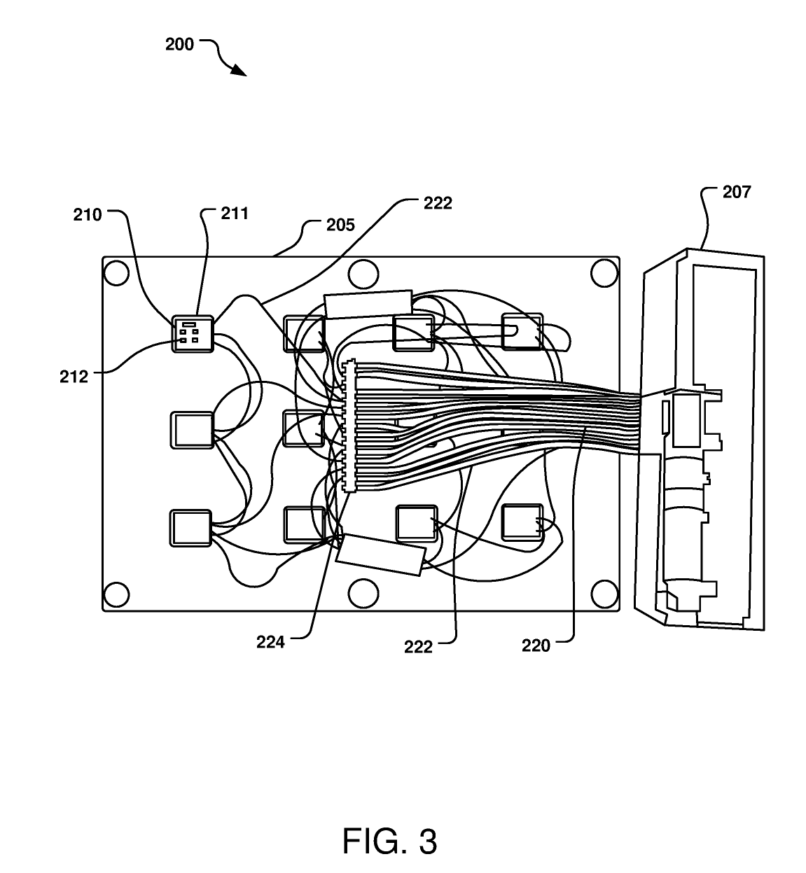

FIG. 3 illustrates the housing of the acoustic measurement surrogate device 200 opened to reveal the wiring harness 220. The housing is shown opened to reveal the inside of the top cover 205 and the body 207.

The wiring harness 220 includes multiple leads 222 (only some of which are shown in FIG. 3), one extending from each microphone 210 along the surface of the top cover 205 to a manifold 224 and to a terminal end (not shown in FIG. 3) having an adaptor to be plugged into a receiver, such as a digital analog converter (DAC) that has appropriate hardware and software to provide a report from the noise data measured by each microphone 210.

Each of the microphones 210 has circuitry 212, in this implementation present within the aperture 211 in the top cover 205 together with the microphone 210, to operate the microphone. The particular microphone 210 used will dictate the circuitry 212 and the connection to the lead 222 of the wiring harness 220; the circuitry 212 is generically shown in FIG. 3.

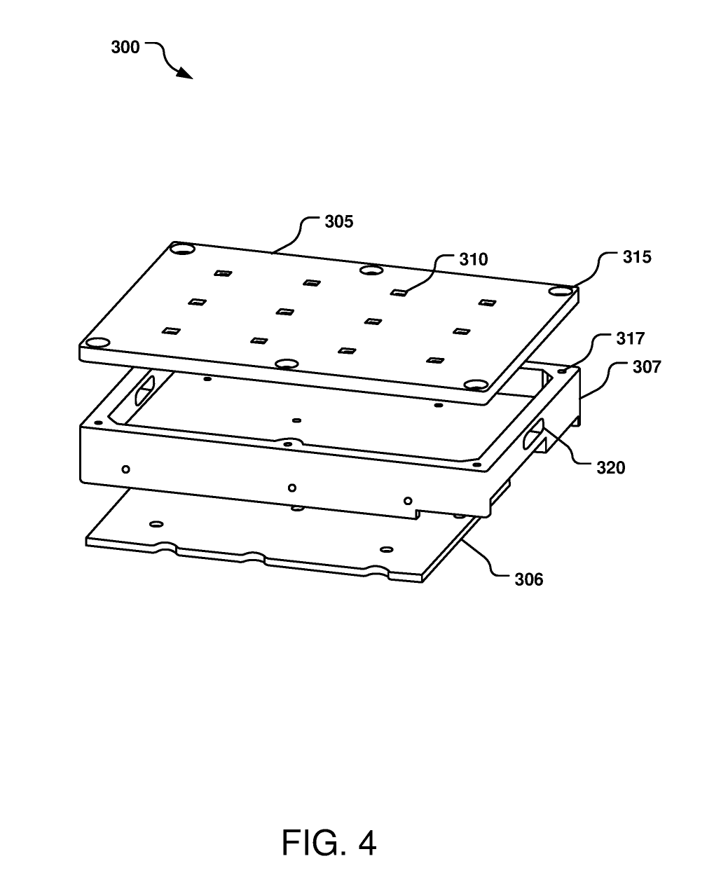

FIG. 4 illustrates an example housing 300 for an acoustic measurement surrogate device. The housing 300 of the acoustic measurement surrogate device has the same form factor of the disc drive for which the device is configured to measure noise. The particular housing 300 of FIG. 4 has a planar top cover 305, an intermediate body 307, and a planar back plate 306. Together, the top cover 305, the intermediate body 307 and the back plate 306 define an interior volume in which the internal components of the acoustic measurement surrogate device (e.g., the circuitry, leads and manifold) are retained. In an operational disc drive, the internal components of the disc drive (e.g., data storage media or disc, actuator, slider, filter, etc.) would be retained in this interior volume. The top cover 305 and the intermediate body 307 can be assembled and held together, e.g., via screws in holes 315, 317, respectively, and the back plate 306 and the intermediate body 307 can be assembled and held together by, e.g., screws. In some implementations, the back plate 306 may be readily releasable and removable from the intermediate body 307, for reasons explained below. Present in the top cover 305 is at least one aperture 310, each aperture 310 for receiving a microphone (e.g., microphone 210 of FIG. 2). In the illustrated implementation, a 3×4 array of apertures 310 is present in the top cover 305. Present in the intermediate body 307 is a channel or slot 320 through which the wiring harness (e.g., wiring harness 220 of FIG. 2) can pass.

When assembled and wired, the acoustic measurement surrogate device can be inserted into any location (e.g., rack system, server, desktop computer, etc.) where a disc drive typically resides, and an accurate understanding of the noise to which the disc drive is exposed can be obtained.

The acoustic measurement surrogate device, such as the acoustic measurement surrogate device 200, has a form factor the same as the disc drive for which the noise is being measured. To obtain a measurement of the noise exposure, the disc drive is removed from its location and replaced with the acoustic measurement surrogate device. The surrogate device is operably connected to a receiver, such as a digital analog converter (DAC) that has appropriate hardware and software to provide a report from the measured noise. From the report, one can determine the noise, e.g., frequency (Hz) and/or level (dB), to which the disc drive is exposed. When more than one microphone is present on the acoustic measurement surrogate device and each microphone is individual, from the report one can determine and distinguish problem areas.

By knowing the noise, e.g., frequency (Hz) and/or level (dB), to which the disc drive is exposed when mounted in its operational location, the potential sources of unacceptable noise can be modified, e.g., insulated, moved, etc. Also by knowing the noise, e.g., frequency (Hz) and/or level (dB), to which the disc drive is exposed when mounted in its operational location, the throughput performance can be determined. Based on the acoustic excitation, the physical features and/or control systems of the disc drive can be modified to better accept and/or withstand the noise and its effect on the operation of the disc drive.

As an example, the housing of the acoustic measurement surrogate device can be changed in an attempt to alter the affect the noise has on the device. For example, if the back plate (e.g., back plate 306 of FIG. 4) is readily removable, noise testing with different designs of back plates could be done to more accurately reproduce the air flow resistance of a particular drive; air flow resistance can affect fan load, thereby affecting fan noise.

In some implementations, having the microphone(s) on only the top cover is sufficient to accurately determine the noise that affects the disc drive; depending on the design of the disc drive housing, the bottom of the intermediate body is sufficiently stiff so that acoustical noise (e.g., vibrations) does not transfer through the back plate to the internal components of the drive.

The housing (e.g., any of housing 203, housing 300) may be formed from appropriate plastic (polymer), metal, or combinations thereof. In some implementations, it may be desired to have the housing formed of the same materials as the disc drive the device is intended to replace. For example, for a housing 300, the planar top cover 305 may be metal and the body 307 and planar back plate 306 may be plastic.

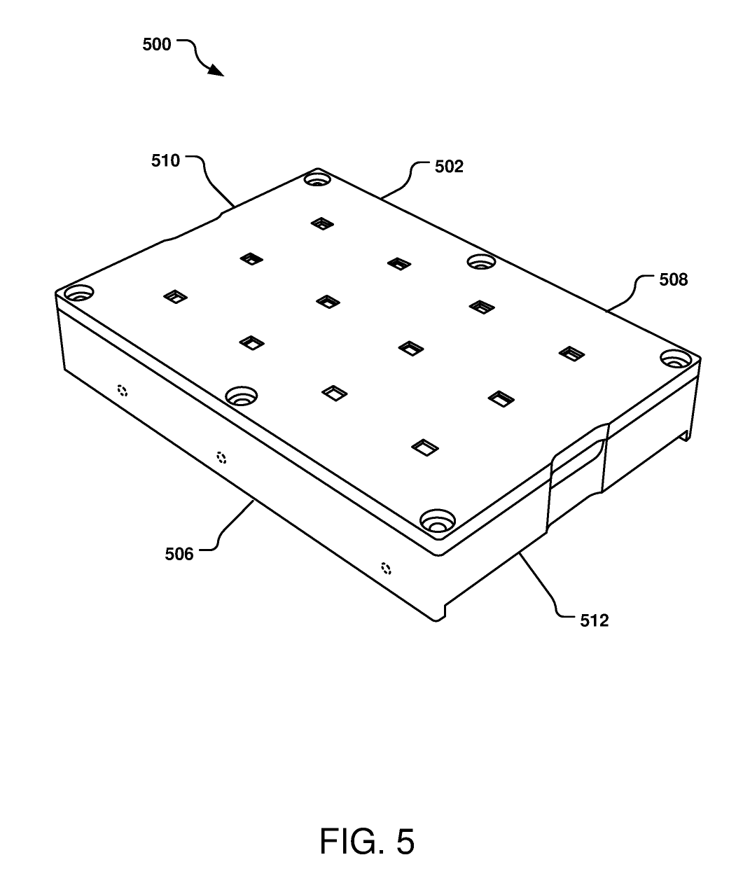

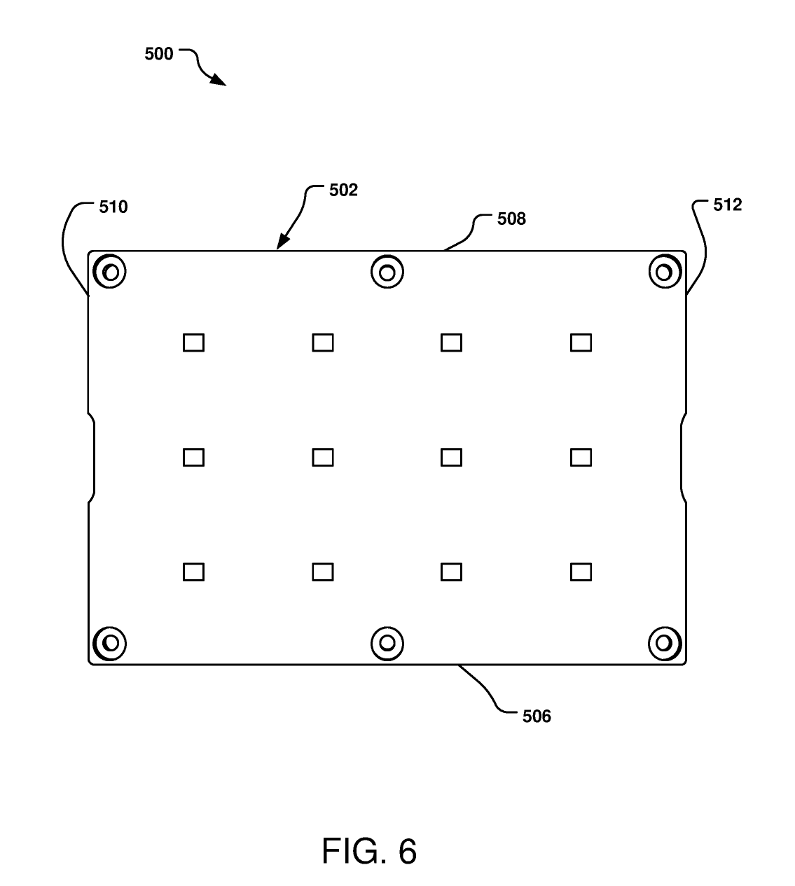

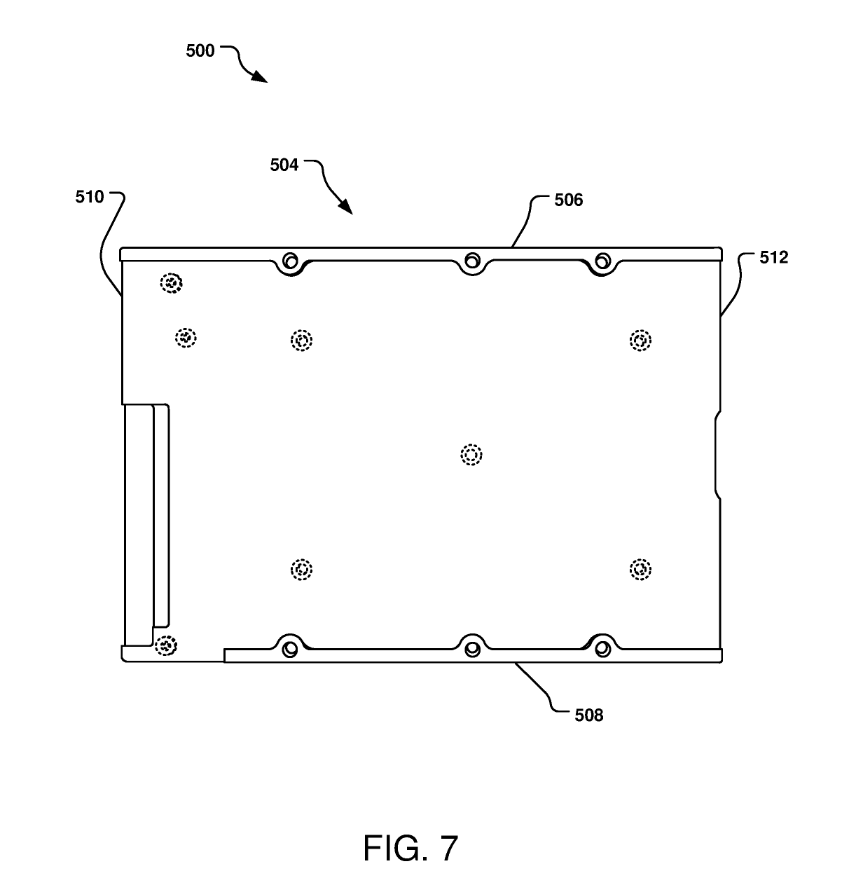

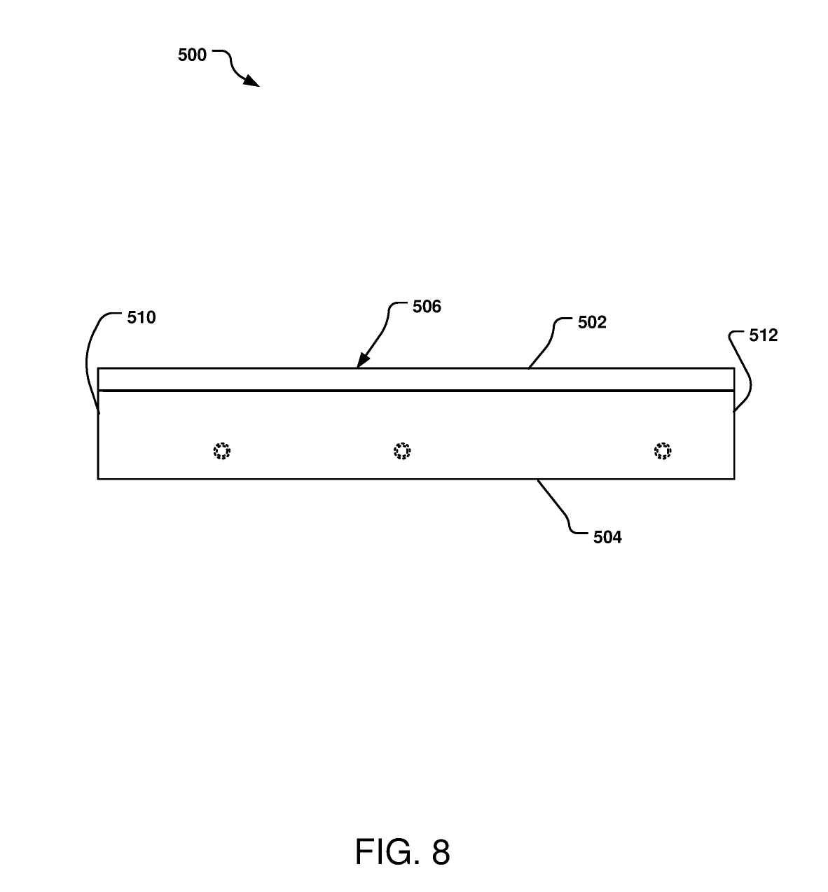

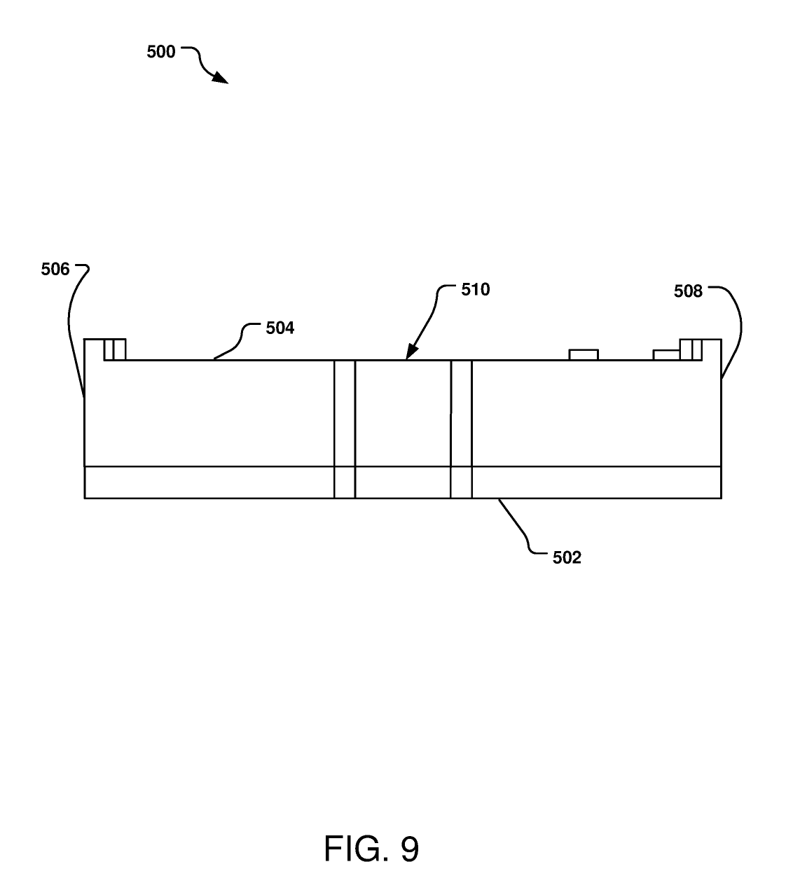

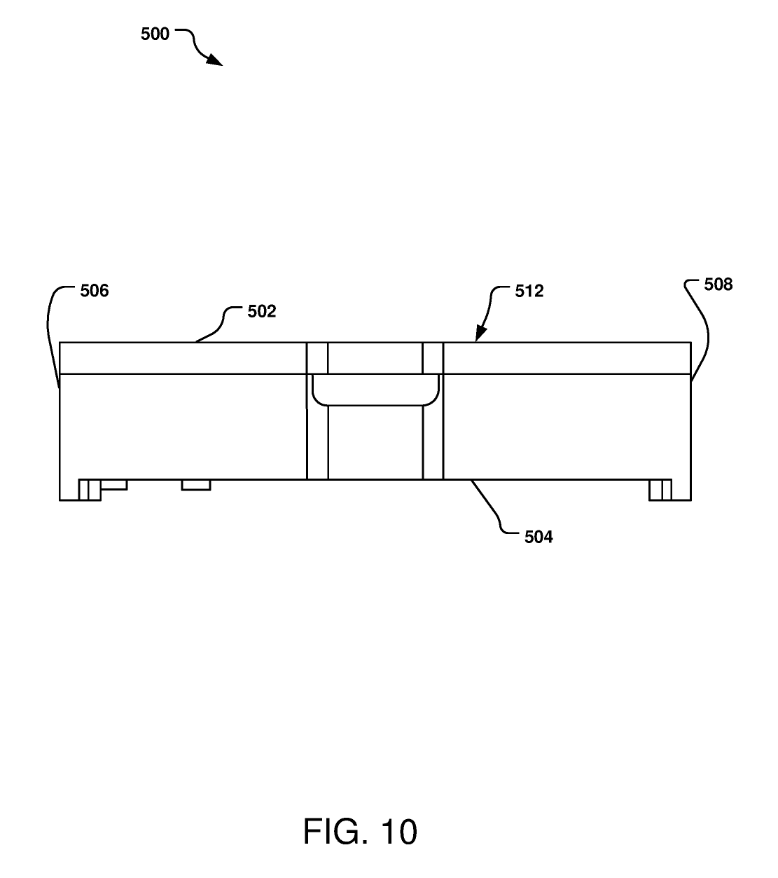

FIGS. 5 through 10 illustrate an acoustic measurement surrogate device 500 from all sides of such a device. FIG. 5 is a perspective view of the acoustic measurement surrogate device 500 and the remaining figures, FIGS. 6 through 10, are plan views of the device 500. FIGS. 5 through 10 show a top side 502, a bottom side 504, a left side 506, a right side 508 same as the left side 506, a back side 510, and a front side 512, which is similar to the back side 510, other than an aperture for a wiring harness to pass therethrough.

Thus, with an acoustic measurement surrogate device as described herein, one can determine the acoustics (noise, by frequency (Hz) and/or level (dB)) to which the disc drive would be exposed to while in place, in real time. With the acoustic measurement surrogate device, an accurate correlation of the noise can be obtained, which can be provided as a report regarding through put performance.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the recited claims.

What is claimed is:

1. An acoustic measurement device for a disc drive having a form factor, the testing device comprising:
a housing having a form factor the same as the disc drive's form factor;
at least one microphone on an exterior surface of the housing;
appropriate circuitry within the housing connecting the at least one microphone to an external device.

2. The acoustic measurement device of claim 1, wherein the external device to which the acoustic measurement device is connected is a digital analog converter.

3. The acoustic measurement device of claim 1, wherein the housing comprises a housing having a body and a planar cover, the at least one microphone mounted in an aperture through the cover.

4. The acoustic measurement device of claim 1, having at least 6 microphones.

5. The acoustic measurement device of claim 4, having at least 12 microphones.

6. The acoustic measurement device of claim 1, wherein the at least one microphone is flush with or recessed in relation to the exterior surface of the housing.

7. The acoustic measurement device of claim 1 having a form factor of a 3½ inch drive and having 12 microphones.

8. The acoustic measurement device of claim 1 having a form factor of a 2½ inch drive and having 6 microphones.

9. The acoustic measurement device of claim 1 configured to be received in any location as the disc drive.

10. A method comprising:
inserting an acoustic measurement device into an apparatus allotted to receive a disc drive with a form factor, the acoustic measurement device having the same form factor and at least one microphone on an exterior surface thereof;
operating the apparatus and collecting acoustic data from the at least one microphone; and
converting the acoustic data to produce a report regarding throughput performance.

11. The method of claim 10, wherein converting the acoustic data to produce a report comprises using a digital analog converter.

12. The method of claim 10, wherein collecting acoustic data from the at least one microphone comprises collecting acoustic data from at least six microphones.
